(19) United States
(12) Patent Application Publication
(10) Pub. No.: US 2026/0341903 A1
(43) Pub. Date: Oct. 29, 2026

(54) COMPOSITE SEPARATOR

(71) Applicant: BenQ Materials Corporation, Taoyuan City (TW)

(72) Inventors: Ching-Ting WENG, Taoyuan City (TW); Ju-Hui HUANG, Taoyuan City (TW)

(21) Appl. No.: 19/274,660

(22) Filed: Jul. 21, 2025

(30) Foreign Application Priority Data
Apr. 18, 2025 (TW) 114114849

(51) Int. Cl. H01M 50/446; H01M 50/417; H01M 50/423; H01M 50/434; H01M 50/443; H01M 50/449; H01M 50/489

(52) U.S. Cl. CPC H01M 50/446; H01M 50/417; H01M 50/423; H01M 50/434; H01M 50/443; H01M 50/449; H01M 50/489

(57) ABSTRACT

A composite separator is disclosed. The composite separator comprises a porous polyolefin substrate and an inorganic coating layer, wherein the inorganic coating layer coated on at least one surface of the porous polyolefin substrate comprises a plurality of inorganic particles, a binder resin, a hydrophilic polymer metal salt, and a polyamide epichlorohydrin resin. The composite separator has good high temperature resistance.

### CROSS-REFERENCE TO RELATED APPLICATION

This application claims priority to Taiwan Application Serial Number 114114849, filed Apr. 18, 2025, which is herein incorporated by reference in its entirety.

### BACKGROUND OF THE INVENTION

### Field of Invention

The present invention relates to a composite separator, and particularly to a composite separator having high temperature resistance.

### Description of Related Art

With the development of the consumer electronics, wearable devices, electric vehicles, and industrial energy storage fields, the safety and energy density requirements of the lithium battery have also increase. As a critical insulating porous material in the lithium batteries, the physical properties of the separator must be further improved. To ensure the safety of lithium-ion batteries, it is necessary to improve the separator's high-temperature tolerance and reduce the thermal shrinkage at elevated temperatures to prevent direct contact between the electrodes under abnormal operating conditions, thereby reducing the risk of thermal runaway.

The separator of the lithium-ion battery is made from polyolefin materials, such as, polyethylene (PE) or polypropylene (PP) and is primary produced by dry-stretching or wet-stretching methods. Both methods involve melting a polymer resin, extruding the molten resin into a film, and then stretching the film to form appropriate pores, either by dry-stretching or wet stretching. Dry-stretched films are generally thicker and can be stacked in multiple layers with high safety and low cost for high power applications. The wet-stretched films, due to the thin thickness, high porosity and uniform pore size are suitable for forming a ceramic coating layer on the surface of a polyolefin film. This results in a composite separator that reduces heat shrinkage and enhances safety. However, applying the ceramic coating layer will lower the ion conductivity of the separator and may even shorten the battery's cycle life. In the state of the art, it is known to add a hydrophilic polymer metal salt into the ceramic coating layer, such as lithium polyacrylate (PAALi), to increase the ion conductivity. However, although the hydrophilic polymer metal salt can increase the ion conductivity, the porous film cannot withstand significant shrinkage at a high temperature, such as, up to 160° C., falling to meet the heat-shrinkage resistant required of the separator, thereby raising safety concern during use.

### SUMMARY OF THE INVENTION

The present invention is to provide a composite separator and particularly to provide a composite separator with high temperature resistance.

The composite separator of the present invention comprises a porous polyolefin substrate and an inorganic coating layer coated on at least one side of the porous polyolefin substrate, wherein the inorganic coating layer comprises a plurality of inorganic particles, a binder resin, a hydrophilic polymer metal salt, and a polyamide epichlorohydrin resin. Based on one hundred weight parts of the inorganic particles, the binder resin is present in an amount ranging from 1.5 weight parts to 8.5 weight parts, the hydrophilic polymer metal salt is present in an amount ranging from 1 weight part to 6 weight parts, and the polyamide epichlorohydrin resin is present in an amount ranging from 0.4 weight parts to 3 weight parts.

In an embodiment of the composite separator of the present invention, the hydrophilic polymer metal salt is, for example, lithium polyacrylate (PAALi), sodium polyacrylate (PAANa), lithium carboxymethyl cellulose (CMCLi), or lithiated poly(perfluoroalkylsulfonyl)imide (PFSILi).

In an embodiment of the composite separator of the present invention, a weight-average molecular weight of the hydrophilic polymer metal salt is ranging from 150,000 to 300,000.

In an embodiment of the composite separator of the present invention, a thickness of the inorganic coating layer is ranging from 0.1 μm to 5.0 μm.

In an embodiment of the composite separator of the present invention, the binder resin is, for example, poly-N-vinyl acetamide, an acrylate-acrylonitrile copolymer, an acrylonitrile-acrylamide-(meth)acrylic acid copolymer, an acrylamide-acrylic acid-(meth)acrylic acid ester copolymer, a (meth)acrylate-(meth)acrylic acid-acrylamide-styrene copolymer, or combinations thereof.

In an embodiment of the composite separator of the present invention, the inorganic coating layer further comprises a wetting agent that is present in an amount of 0.5 weight parts to 3.0 weight parts based on per hundred weight parts of the inorganic particles.

In an embodiment of the composite separator of the present invention, the inorganic particles used in the inorganic coating layer are, for example, Mg(OH)₂, BaSO₄, BaTiO₃, HfO₂, SrTiO₃, SnO₂, CeO₂, MgO, NiO, CaO, ZnO, ZrO₂, SiO₂, Y₂O₃, Al(OH)₃, Al₂O₃, Boehmite (AlOOH), SiC, TiO₂, or combinations thereof.

In an embodiment of the composite separator of the present invention, the inorganic coating layer further comprises a thickener, an antistatic agent, a flame retardant, antioxidant, a dispersant, a defoamer, or a surface modifier.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In the following description, numerous specific details are described in detail in order to enable the reader to fully understand the following examples. However, embodiments of the present invention may be practiced in case no such specific details.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The composite separator of the present invention comprises a porous polyolefin substrate and an inorganic coating layer coated on at least one side of the porous polyolefin substrate. The porous polyolefin substrate suitably used in the present composite separator can be a single-layered or multi-layered porous polyolefin substrate, for example, single-layered polyethylene, single-layered polypropylene, double-layered polyethylene/polypropylene, or tri-layer polypropylene/polyethylene/polypropylene, but not limited thereto. A thickness of the porous polyolefin substrate suitably used in the present invention is between 5 μm and 30 μm and is preferably between 5 μm and 20 μm, and a porosity of the porous polyolefin substrate is between 40% and 70%, preferably between 43% and 65%.

The inorganic coating layer of the composite separator can be coated on one side or both sides of the porous polyolefin substrate. In an embodiment of the present composite separator, a thickness of the inorganic coating layer is ranging from 0.1 μm to 5.0 μm, and is preferably a single-sided or double-sided coating layer having a thickness ranging from 2.0 μm to 3.5 μm.

The inorganic coating layer of the present composite separator comprises a plurality of the inorganic particles, a binder resin, a hydrophilic polymer metal salt, and a polyamide epichlorohydrin resin. The inorganic particles used in the inorganic coating layer may be those commonly used in the related art, that is, the inorganic particles that possess heat resistance, electrical insulation properties, and stability to the electrolyte, without particular limitation. The suitable inorganic particles can be, for example, Mg(OH)₂, BaSO₄, BaTiO₃, HfO₂, SrTiO₃, SnO₂, CeO₂, MgO, NiO, CaO, ZnO, ZrO₂, SiO₂, Y₂O₃, Al(OH)₃, Al₂O₃, Boehmite (AlOOH), SiC or TiO₂. The average particle size (D50) of the inorganic particles can be ranging from 0.1 μm to 2.0 μm and is preferably ranging from 0.15 μm to 1.0 μm. In an embodiment of the present invention, the inorganic coating layer can comprise two or more type of inorganic particles having the same or different particles size.

In the inorganic coating layer of the present composite separator, the binder resin can be the resins commonly used in the art, such as, poly-N-vinyl acetamide, an acrylate-acrylonitrile copolymer, an acrylonitrile-acrylamide-(meth)acrylic acid copolymer, an acrylamide-acrylic acid-(meth)acrylic acid ester copolymer, a (meth)acrylate-(meth)acrylic acid-acrylamide-styrene copolymer, or combinations thereof, so as to prevent the adhesion from decreasing between the inorganic coating layer and the porous polyolefin substrate due to the high polarity and multiple ionic bonds of the hydrophilic polymer metal salt. Based on per hundred weight parts of the inorganic particles, the binder resin is present in an amount ranging from 1.5 weight parts to 8.5 weight parts, and preferably from 2 weight parts to 7.5 weight parts. When the amount of the binder resin is too high, it may adversely affect the air permeability of the separator. The binder resin suitably used in the present invention can be commercial products, for example, BM-950B (available from ZEON Corp. JP), CYJ5088A (available from Zhuhai Chenyu New Material Technology Co Ltd, China), PNVA GE191 series like GE191-103, GE191-104, GE191-107, or GE191-108 (available from Showa Denko K.K., JP), SF168L (available from Shenzhen Yanyi New Materials Co Ltd, China), or GR506 (available from Hunan Rui Rui Power Materials Co Ltd, China), but not limited thereto.

In the composite separator of the present invention, the hydrophilic polymer metal salt of the inorganic coating layer can dissociate to from metal ions, thereby supplementing the metal source and compensating for part of the battery capacity loss, which can accelerate ion migration and contribute to improved battery performance. In an embodiment of the composite separator of the present invention, the hydrophilic polymer metal salt can be, for example, but not limited to lithium polyacrylate (PAALi), sodium polyacrylate (PAANa), lithium carboxymethyl cellulose (CMCLi), or lithiated poly(perfluoroalkylsulfonyl)imide (PFSILi). A weight-average molecular weight of the hydrophilic polymer metal salt is ranging from 150,000 to 300,000, for example, 150,000, 200,000, 250,000, or 300,000. In the inorganic coating layer of the present composite separator, based on per hundred weight parts of the inorganic particles, the hydrophilic polymer metal salt is present in an amount ranging from 1 weight part to 6 weight parts, and is preferably ranging from 1.5 weight parts to 5 weight parts. If the amount of the hydrophilic polymer metal salt is too low, the ion migration may not be effectively enhanced, and if the amount of the hydrophilic polymer metal salt is too high, the impedance of the separator may be increased to adversely affect the battery performance.

Moreover, the inorganic coating layer of the present composite separator comprises the polyamide epichlorohydrin resin. Through the condensation reaction between the polyamide epichlorohydrin resin and the carboxyl groups in the hydrophilic polymer metal salt, van der Waals forces can be enhanced and thus, to enhance the overall strength and the thermal stability of the separator without adversely affecting ion migration. If the amount of the polyamide-epichlorohydrin resin is too low, the thermal stability of the separator may be insufficient. In an embodiment of the composite separator of the present invention, based on per hundred weight parts of the inorganic particles, the amount of the polyamide epichlorohydrin resin is between 0.4 weight parts to 3 weight parts, and preferably between 0.45 weight parts to 2.5 weight parts. If the amount of the polyamide epichlorohydrin resin is too high, it may adversely affect the uniformity of the inorganic coating layer.

The polyamide epichlorohydrin resin suitable for use in the inorganic coating layer of the present composite separator can have a weight-average molecular weight of about 200,000 to 300,000, for example, 200,000, 220,000, 240,000, 260,000, 280,000, or 300,000, and has a chemical structure represented by the following formula (I):

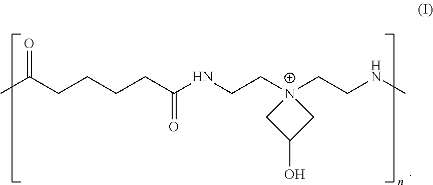

In an embodiment of the composite separator of the present invention, the suitable polyamide epichlorohydrin resin can be commercial products, such as, Polycup 172, Polycup 7700, Polycup 2000 commercially available from Solenis LLC, US., but not limited to.

The inorganic coating layer of the present composite separator comprises the hydrophilic polymer metal salt, the addition of polyamide epichlorohydrin resin to the inorganic coating layer can enable resistance to shrinkage of the polyolefin porous substrate at high temperature, so as to maintain the thermal shrinkage resistance at a high temperature (such as at 180° C.) even under the condition of high ion migration. Accordingly, even the inorganic coating layer is relatively thin, such as a thickness of less than 5 μm, the thermal shrinkage rate can be no greater than 2% in both machine direction (MD) and transverse direction (TD) after heating at 180° C. for 1 hour. The low shrinkage rate at the elevated temperature prevents electrode contact and subsequent thermal runaway during application abnormalities. This provide excellent safety performance at high temperature. In addition, the binder used in the present invention provides sufficient adhesion, allowing the inorganic coating layer and the polyolefin porous substrate to possess suitable interfacial adhesion, such as a peeling strength greater than 10 gf/cm.

In an embodiment of the composite separator of the present invention, the binder resin can further comprise a wetting agent to enhance the interface affinity between the inorganic coating layer and the porous polyolefin substrate. The wetting agent suitably used in the present invention can be siloxane-based surfactants. The amount of the wetting agent used can be in the range of 0.5 weight parts to 3.0 weight parts based on per hundred weight parts of the inorganic particles and preferably in the range of 0.5 weight parts to 2.5 weight parts.

In an embodiment of the composite separator of the present invention, the inorganic coating layer may further comprise additives such as antistatic agents, flame retardants, antioxidants, dispersants, defoamers, or surface modifiers as needed.

Accordingly, by using the polyamide epichlorohydrin resin to enhance the thermal shrinkage resistance of the composite separator, it can avoid concerns about the battery safety caused by the addition of the hydrophilic polymer metal salt to the inorganic coating to affect the heat resistance. In a preferred embodiment of the composite separator of the present invention, the thermal shrinkage rate after heating at 180° C. for 1 hour can still be no greater than 2% in both the machine direction (MD) and the transverse direction (TD).

The present invention will be explained in further detail with reference to the examples. However, the present invention is not limited to these examples.

### EXAMPLE

The materials below are used in following examples:
SA0-030EN: aluminum oxide (Al₂O₃), particle size (D50): 0.52 μm, available from Shandong Sinocera Functional Materials Co., Ltd., China
PAA: a poly(acrylic acid) solution, 35 wt %, the weight-average molecular weight (Mw) of about 250,000, available from Sigma-Aldrich Corp. US
CYJ5088A: an acrylate-acrylic acid-acrylamide-styrene copolymer emulsion, a solid content of 25%, available from Zhuhai Chenyu New Material Technology Co Ltd, China
SF168L: an acrylonitrile-acrylamide-acrylic acid copolymer emulsion, solid content: 6.25%, glass transition temperature (Tg): 180° C., available from Shenzhen Yanyi New Materials Co., Ltd., China
Polycup 172: a polyamide epichlorohydrin (PAE) resin, a solid content of 12.5%, viscosity (25° C.) of 25 cps to 75 cps, pH of 4.0 to 5.0, available from Solenis LLC, US
Polycup 7700: a polyamide epichlorohydrin (PAE) resin, a solid content of 12.5%, viscosity (25° C.) of 30 cps to 90 cps, pH of 3.3 to 4.1, available from Solenis LLC, US
Polycup 2000: a polyamide epichlorohydrin (PAE) resin, a solid content of 12%, viscosity (25° C.) of less than 100 cps, pH of 2.2 to 4.0, available from Solenis LLC, US
BYK-ET-3030: a dispersant, a solid content of 42%, available from BYK, Germany
BYK-ET-3061: a polyether-modified silicone surfactant, available from BYK, Germany
SF-3100: a wetting agent, available from Eerpure Co., Ltd, Taiwan
BYK-ET-3070: a defoamer, a solid content of 30%, available from BYK, Germany

### Preparation Example 1—Preparation of PAALi Solution

11.6 g of LiOH (486 mmol) was dissolved in 100 mL deionized water, and 100 g of PAA solution was added. The mixture was stirred and mixed by a magnetic stirrer for 8 hours to obtain a PAALi solution with pH 7 and a concentration of 22%.

### Example 1

31.36 g of the aluminum oxide (SA0-030EN), 1.57 g of the acrylate-acrylic acid-acrylamide-styrene copolymer emulsion (CYJ5088A), 6.27 g of the acrylonitrile-acrylamide-acrylic acid copolymer emulsion (SF168L), 2.87 g of the PAALi solution obtained from Example 1, 1.18 g of the polyamide epichlorohydrin resin (Polycup 172), 0.43 g of the dispersant (BYK-ET-3030), 0.51 g of the defoamer (BYK-ET-3070), and 0.75 g of the wetting agent (BYK-ET-3061) were added into 55.07 g of the deionized water, and then mixed and stirred uniformly to obtain an inorganic particles slurry.

The obtained inorganic particles slurry was coated on both sides of a polyethylene porous film with a thickness of 9.2 μm (porosity 48%) and then, dried to form an inorganic coating layer on the polyethylene porous film to obtained a composite separator with a thickness of 12.0 μm.

The obtained composite separator was tested by the following testing methods. The testing results were shown as the following Table 1.

Measurement of Thickness: The thickness of the separator was measured according to GB/T6672-2001. The thickness Analyzer (VL-50-B, available from Mitutoyo, Japan) was used to measure the thickness of the separator. The measurement was conducted by a flat probe with a diameter of 3 mm under a measuring force of 0.01 N.

Measurement of Gurley number: The Gurley number was measured according to ASTM D-726. The separator was cut into a sample of 1 inch×1 inch and tested by an air permeability tester. The Gurley number was obtained by measuring the time for 100 C.C. of air to pass through the separator.

Lithium ion transference number test: The prepared composite separator was assembled into a coin cell, and an AC impedance test was conducted by using a Biologic battery testing system at frequencies ranging from 100 kHz to 1 Hz to measure internal resistance. A DC bias of 15 mV was applied, and the change in current over time was recorded for 1 hour. The lithium ion transference number (T₊) was calculated according to the following Bruce-Vincent equation,

$${T}_{+} = \frac{{I}_{s} ( V - {I}_{0} {R}_{0} )}{{I}_{0} ( V - {I}_{s} {R}_{s} )} ,$$

wherein V represents the applied voltage, I₀ and Iₛ represent the initial and steady-state currents, respectively, and R₀ and Rₛ represent the initial and steady-state resistances, respectively.

Thermal shrinkage test: A 10×10 cm sample was cut, and the initial lengths in the machine direction (MD) and transverse direction (TD), denoted as M0 and TO, respectively, were marked at the center of the sample prior to testing. After marking, the sample was placed between two sheets of A4 paper and placed into an oven to be heated at 180° C. for 1 hour. After heating was completed, the sample was allowed to stand in the same environment as the measuring apparatus for 30 minutes. The lengths at the center of the sample in the MD and TD directions, denoted as M1 and T1 respectively, were then measured. If both MD thermal shrinkage rate and TD thermal shrinkage rate were less than 2%, the result was indicated as “O”, if either MD thermal shrinkage rate or TD thermal shrinkage rate exceeded 2%, the result was indicated as “X”.

Thermal shrinkage ratio in the machine direction (MD)=(M0−M1)/M0×100%

Thermal shrinkage ratio in the transverse direction (TD)=(T0−T1)/T0×100%

Measurement of peeling strength: An adhesive film (Model no. 31B, available from Nitto Denko Corporation) with a thickness of 80 μm was cut into a strip test piece with a length of 60 mm and a width of 20 mm, and adhered to a composite separator. Then, the 180-degree peeling strength of middle section of 50 mm in a longitudinal direction of the strip test piece peeled-off from the composite separator was measured by an universal tensile machine at a pulling rate of 50 mm/min. An average peeling strength of a composite separator was calculated by averaging peeling strengths measured by peeling-off 5 strip test pieces from the composite separator.

### Example 2

31.26 g of the aluminum oxide (SA0-030EN), 1.56 g of the acrylate-acrylic acid-acrylamide-styrene copolymer emulsion (CYJ5088A), 6.20 g of the acrylonitrile-acrylamide-acrylic acid copolymer emulsion (SF168L), 2.86 g of the PAALi solution obtained from Preparation Example 1, 2.08 g of the polyamide epichlorohydrin resin (Polycup 172), 0.43 g of the dispersant (BYK-ET-3030), 0.51 g of the defoamer (BYK-ET-3070), and 0.75 g of the wetting agent (BYK-ET-3061) were added into 54.35 g of the deionized water, and then mixed and stirred uniformly to obtain an inorganic particles slurry.

The obtained inorganic particles slurry was coated on both sides of a polyethylene porous film with a thickness of 9.2 μm (porosity 48%) and then, dried to form an inorganic coating layer on the polyethylene porous film to obtained a composite separator with a thickness of 12.7 μm.

The obtained composite separator was tested by the testing methods described in Example 1. The testing results were shown as the following Table 1.

### Example 3

30.69 g of the aluminum oxide (SA0-030EN), 1.53 g of the acrylate-acrylic acid-acrylamide-styrene copolymer emulsion (CYJ5088A), 6.14 g of the acrylonitrile-acrylamide-acrylic acid copolymer emulsion (SF168L), 5.58 g of the PAALi solution obtained from Preparation Example 1, 2.05 g of the polyamide epichlorohydrin resin (Polycup 172), 0.44 g of the dispersant (BYK-ET-3030), 0.51 g of the defoamer (BYK-ET-3070), and 0.74 g of the wetting agent (BYK-ET-3061) were added into 52.34 g of the deionized water, and then mixed and stirred uniformly to obtain an inorganic particles slurry.

The obtained inorganic particles slurry was coated on both sides of a polyethylene porous film with a thickness of 9.2 μm (porosity 48%) and then, dried to form an inorganic coating layer on the polyethylene porous film to obtained a composite separator with a thickness of 12.6 μm.

The obtained composite separator was tested by the testing methods described in Example 1. The testing results were shown as the following Table 1.

### Example 4

26.86 g of the aluminum oxide (SA0-030EN), 1.34 g of the acrylate-acrylic acid-acrylamide-styrene copolymer emulsion (CYJ5088A), 5.37 g of the acrylonitrile-acrylamide-acrylic acid copolymer emulsion (SF168L), 4.88 g of the PAALi solution obtained from Preparation Example 1, 4.48 g of the polyamide epichlorohydrin resin (Polycup 7700), 0.38 g of the dispersant (BYK-ET-3030), and 0.64 g of the wetting agent (FS-3100) were added into 56.03 g of deionized water, and then mixed and stirred uniformly to obtain an inorganic particles slurry.

The obtained inorganic particles slurry was coated on both sides of a polyethylene porous film with a thickness of 9.2 μm (porosity 48%) and then, dried to form an inorganic coating layer on the polyethylene porous film to obtained a composite separator with a thickness of 12.5 μm.

The obtained composite separator was tested by the testing methods described in Example 1. The testing results were shown as the following Table 1.

### Example 5

27.40 g of the aluminum oxide (SA0-030EN), 1.37 g of the acrylate-acrylic acid-acrylamide-styrene copolymer emulsion (CYJ5088A), 5.48 g of the acrylonitrile-acrylamide-acrylic acid copolymer emulsion (SF168L), 4.98 g of the PAALi solution obtained from Preparation Example 1, 4.57 g of the polyamide epichlorohydrin resin (Polycup 2000), 0.39 g of the dispersant (BYK-ET-3030), and 0.66 g of the wetting agent (FS-3100) were added into 55.16 g of the deionized water, and then mixed and stirred uniformly to obtain an inorganic particles slurry.

The obtained inorganic particles slurry was coated on both sides of a polyethylene porous film with a thickness of 9.2 μm (porosity 48%) and then, dried to form an inorganic coating layer on the polyethylene porous film to obtained a composite separator with a thickness of 12.4 μm.

The obtained composite separator was tested by the testing methods described in Example 1. The testing results were shown as the following Table 1.

### Comparative Example 1

27.95 g of the aluminum oxide (SA0-030EN), 1.40 g of the acrylate-acrylic acid-acrylamide-styrene copolymer emulsion (CYJ5088A), 5.59 g of the acrylonitrile-acrylamide-acrylic acid copolymer emulsion (SF168L), 5.08 g of the PAALi solution obtained from Preparation Example 1, 0.40 g of the dispersant (BYK-ET-3030), and 0.67 g of the wetting agent (BYK-ET-3061) were added into 58.93 g of the deionized water, and then mixed and stirred uniformly to obtain an inorganic particles slurry.)

The obtained inorganic particles slurry was coated on both sides of a polyethylene porous film with a thickness of 9.2 μm (porosity 48%) and then, dried to form an inorganic coating layer on the polyethylene porous film to obtained a composite separator with a thickness of 12.6 μm.

The obtained composite separator was tested by the testing methods described in Example 1. The testing results were shown as the following Table 1.

TABLE 1
The testing results of the composite separator
of the Examples and the Comparative Example

| | | | | | | Comparative |
|---|---|---|---|---|---|---|
| | Example 1 | Example 2 | Example 3 | Example 4 | Example 5 | Example 1 |
| PAALi amount | 2.0% | 2.0% | 4.0% | 2.0% | 2.0% | 4.0% |
| (based on per hundred | | | | | | |
| weight parts of | | | | | | |
| aluminum oxide) | | | | | | |
| PAE amount | 0.45% | 0.80% | 0.80% | 2.00% | 2.00% | 0 |
| (based on per hundred | | | | | | |
| weight parts of | | | | | | |
| aluminum oxide) | | | | | | |
| Thickness of | 2.8 | 3.5 | 3.1 | 3.3 | 3.2 | 3.4 |
| inorganic coating | | | | | | |
| layer (μm) | | | | | | |
| Gurley (sec/100 c.c.) | 101 | 113 | 119 | 132 | 132 | 115 |
| Thermal Shrinkage | ◯ | ◯ | ◯ | ◯ | ◯ | X |
| (180 °C@ 1 hr) | | | | | | |
| Peeling Strength | 18 | 16 | 31 | 22 | 28 | 15 |
| (gf/cm) | | | | | | |
| Lithium ion | 0.7 | 0.7 | 0.8 | 0.7 | 0.7 | 0.8 |
| transference number | | | | | | |

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A composite separator comprising:
a porous polyolefin substrate; and an inorganic coating layer coated on at least one side of the porous polyolefin substrate, wherein the inorganic coating layer comprises a plurality of inorganic particles, a binder resin, a hydrophilic polymer metal salt, and a polyamide epichlorohydrin resin; wherein based on one hundred weight parts of the inorganic particles, the binder resin is present in an amount ranging from 1.5 weight parts to 8.5 weight parts, the hydrophilic polymer metal salt is present in an amount ranging from 1 weight part to 6 weight parts, and the polyamide epichlorohydrin resin is present in an amount ranging from 0.4 weight parts to 3 weight parts.

2. The composite separator as claimed in claim 1, wherein the hydrophilic polymer metal salt is lithium polyacrylate (PAALi), sodium polyacrylate (PAANa), lithium carboxymethyl cellulose (CMCLi), or lithiated poly(perfluoroalkylsulfonyl)imide (PFSILi).

3. The composite separator as claimed in claim 1, wherein a weight-average molecular weight of the hydrophilic polymer metal salt is ranging from 150,000 to 300,000.

4. The composite separator as claimed in claim 1, wherein a thickness of the inorganic coating layer is ranging from 0.1 μm to 5.0 μm.

5. The composite separator as claimed in claim 1, wherein the binder resin is poly-N-vinyl acetamide, an acrylate-acrylonitrile copolymer, an acrylonitrile-acrylamide-(meth)acrylic acid copolymer, an acrylamide-acrylic acid-(meth)acrylic acid ester copolymer, a (meth)acrylate-(meth)acrylic acid-acrylamide-styrene copolymer, or combinations thereof.

6. The composite separator as claimed in claim 1, wherein the inorganic particles used in the inorganic coating layer are Mg(OH)₂, BaSO₄, BaTiO₃, HfO₂, SrTiO₃, SnO₂, CeO₂, MgO, NiO, CaO, ZnO, ZrO₂, SiO₂, Y₂O₃, Al(OH)₃, Al₂O₃, Boehmite (AlOOH), SiC, TiO₂, or combinations thereof.

7. The composite separator as claimed in claim 1, wherein the inorganic coating layer further comprises a wetting agent, the wetting agent that is present in an amount of 0.5 weight parts to 3.0 weight parts based on per hundred weight parts of the inorganic particles.

8. The composite separator as claimed in claim 1, wherein the inorganic coating layer further comprises a thickener, an antistatic agent, a flame retardant, antioxidant, a dispersant, a defoamer, or surface modifier.
